(19) United States
(12) Patent Application Publication
(10) Pub. No.: US 2012/0242580 A1
(43) Pub. Date: Sep. 27, 2012

(54) INPUT DEVICE

(75) Inventor: TAMOTSU YAMAMOTO, Hyogo (JP)

(73) Assignee: PANASONIC CORPORATION, Osaka (JP)

(21) Appl. No.: 13/413,989

(22) Filed: Mar. 7, 2012

(30) Foreign Application Priority Data
Mar. 25, 2011 (JP) 2011-067244

(51) Int. Cl. G06F 3/041; G06F 3/02

(52) U.S. Cl. 345/168; 345/173

(57) ABSTRACT

An input device including a touch panel, and a control circuit which is electrically coupled to the touch panel and which determines a pressing force on the touch panel. When the pressing force is not larger than a predetermined first value, the control circuit sets the touch panel to an input state; when the pressing force is larger than the first value and not larger than a predetermined second value, the control circuit sets the touch panel to a standby state; and when the pressing force is larger than the second value, the control circuit decides an input to the touch panel and sets the touch panel to the input state.

### BACKGROUND

1. Technical Field

The technical field relates to an input device used in operations of various electronic apparatuses.

2. Background Art

Recently, electronic apparatuses such as a portable telephone or a music player have had a higher function or a smaller size. Input devices having more excellent operability to be used in such electronic apparatuses are demanded.

FIG. 7 is an exploded perspective view of an electronic apparatus using a conventional input device. Wiring patterns are formed on upper and lower surfaces of wiring board 1. For example, control circuit 2 including microcomputer or the like and connector 3 are provided on the lower surface of wiring board 1. Input device 8 includes wiring board 1, spacer sheet 5, display element 6, and touch panel 7. Spacer sheet 5 made of an insulating resin, display element 6 such as a liquid crystal display, and touch panel 7 are overlaid on the upper surface of wiring board 1. Touch panel 7 is coupled to connector 3 by wiring cable 7A. Control circuit 2 is electrically coupled to touch panel 7 via connector 3.

Input device 8 is disposed between lower case 9 and upper case 10. Touch panel 7 is disposed at the lower side of operation window 10A provided in upper case 10. Operation window 10A is covered with translucent cover 11 made of a resin film, glass, or the like.

For example, formation of text to be transmitted by electronic mail in electronic apparatus 12 is described below.

FIG. 8 is a top view of the electronic apparatus using the conventional input device. Text display part 13 and a plurality of keys 14 are displayed on display element 6. An operator of a top surface of touch panel 7 inputs a character by touching a part corresponding to each of keys 14.

When an operator inputs a character, the contents of chosen key 14 are decided immediately after the operator touches touch panel 7. Therefore, an input error may occur.

### SUMMARY

An input device of the present embodiment includes a touch panel, and a control circuit which is electrically coupled to the touch panel and which determines a pressing force on the touch panel. When the pressing force is not larger than a predetermined first value, the control circuit sets the touch panel to an input state; when the pressing force is larger than the first value and not larger than a predetermined second value, the control circuit sets the touch panel to a standby state. When the pressing force is larger than the second value, the control circuit decides an input to the touch panel and sets the touch panel to the input state.

### BRIEF DESCRIPTION OF THE DRAWINGS

FIG. 1 is an exploded perspective view of an electronic apparatus using an input device in accordance with an embodiment.

FIG. 2 is a partial sectional view of the electronic apparatus using the input device in accordance with the embodiment.

FIG. 3A is a top view of the electronic apparatus using the input device in accordance with the embodiment.

FIG. 3B is a top view of the electronic apparatus using the input device in accordance with the embodiment.

FIG. 4A is a top view of the electronic apparatus using the input device in accordance with the embodiment.

FIG. 4B is a top view of the electronic apparatus using the input device in accordance with the embodiment.

FIG. 5 is a block diagram showing a relation among a touch panel, a control circuit and a display part or a vibration part or a sound generation part in accordance with the embodiment.

FIG. 6 is a graph showing a relation between a pressing force and a voltage value in the input device in accordance with the embodiment.

FIG. 7 is an exploded perspective view of an electronic apparatus using a conventional input device.

FIG. 8 is a top view of the electronic apparatus using the conventional input device.

### DETAILED DESCRIPTION

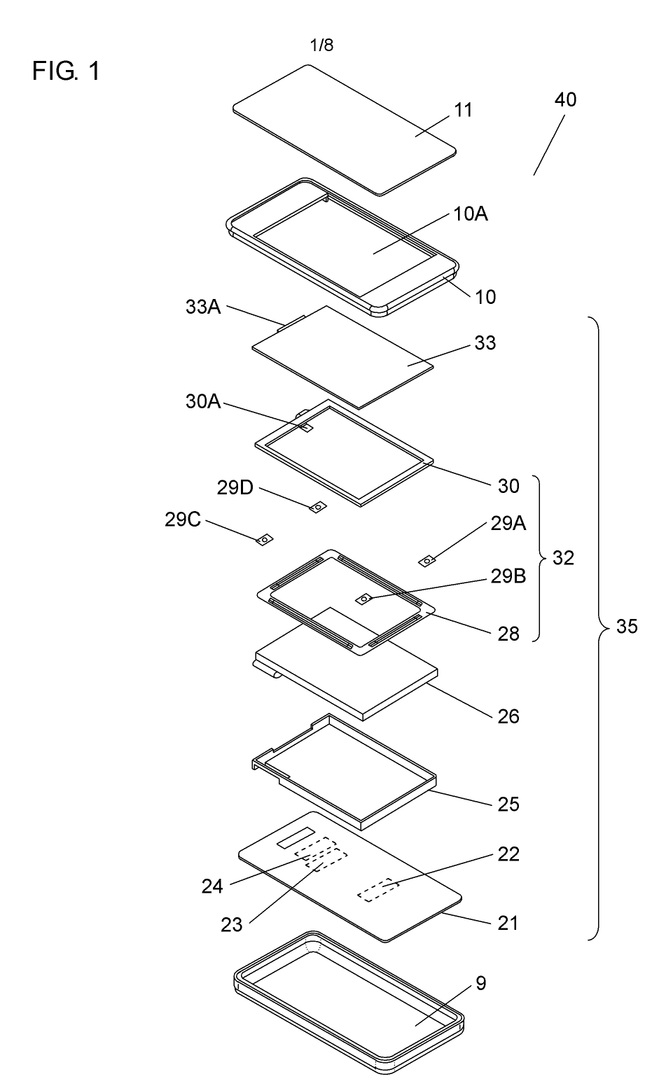

Hereinafter, an embodiment is described with reference to FIGS. 1 to 6. These drawings are shown in a partially enlarged size for easily understanding configurations.

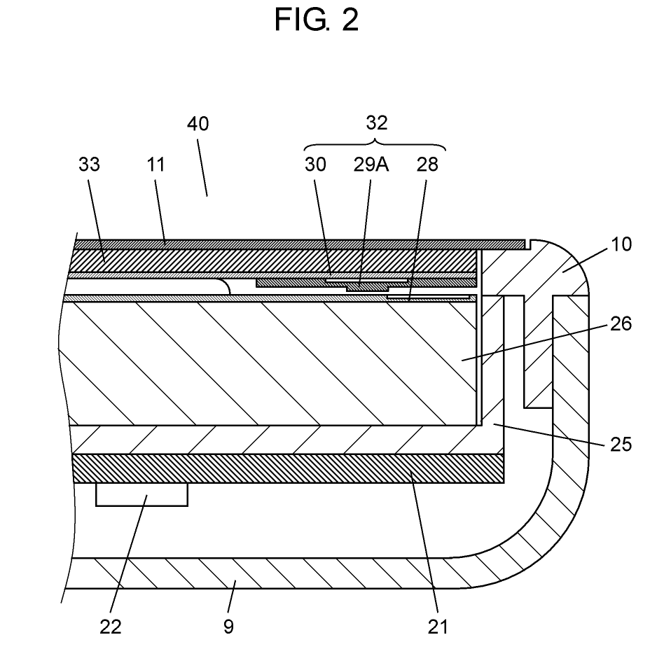

FIG. 1 is an exploded perspective view of an electronic apparatus using an input device in accordance with an embodiment. FIG. 2 is a partial sectional view of the electronic apparatus using the input device in accordance with the embodiment. Input device 35 of the embodiment includes touch panel 33, and control circuit 22 which is electrically coupled to touch panel 33 and which determines a pressing force on touch panel 33.

Wiring patterns are formed on upper and lower surfaces of wiring board 21. For example, control circuit 22 such as microcomputer, and connectors 23 and 24 are provided on the lower surface of wiring board 21. Control circuit 22 is electrically coupled to connectors 23 and 24 via the wiring pattern. Box-like holder 25 made of an insulating resin is disposed at the upper side of wiring board 21. Display element 26 such as a liquid crystal display is housed in holder 25.

Pressure-sensitive sheet 32 includes spacer 28, pressure-sensitive sensors 29A to 29D, and wiring sheet 30.

Pressure-sensitive sensors 29A to 29D are disposed in four corners on the top surface of rectangular frame-shaped spacer 28 made of an insulating resin. Outputs of pressure-sensitive sensors 29A to 29D change according to a pressing force on the top surface. At the upper side of pressure-sensitive sensors 29A to 29D, rectangular frame-shaped wiring sheet 30 covered with an insulating resin is disposed.

Control circuit 22 is electrically coupled to pressure-sensitive sheet 32 via connector 24. Pressure-sensitive sensors 29A to 29D perceive a pressing force, and a signal thereof is transmitted to control circuit 22 via wiring sheet 30.

Touch panel 33 is disposed on the top surface of pressure-sensitive sheet 32. Wiring cable 33A extending from touch panel 33 is connected to connector 23. Wiring cable 30A extending from wiring sheet 30 of pressure-sensitive sheet 32 is connected to connector 24. Control circuit 22 is electrically coupled to touch panel 33 via connector 23.

That is to say, control circuit 22 determines a pressed position of touch panel 33 based on an output of touch panel 33, and determines a pressing force based on an outputs of pressure-sensitive sensors 29A to 29D.

Holder 25, display element 26, pressure-sensitive sheet 32 and touch panel 33 are disposed at the upper side of wiring board 21 provided with control circuit 22.

Electronic apparatus 40 includes input device 35, lower case 9, upper case 10, and cover 11.

Input device 35 is disposed between lower case 9 and upper case 10. Upper case 10 has operation window 10A. Operation window 10A is covered with translucent cover 11 made of a material such as a resin film or glass.

For example, an operation of forming text to be transmitted by electronic mail in electronic apparatus 40 is described below.

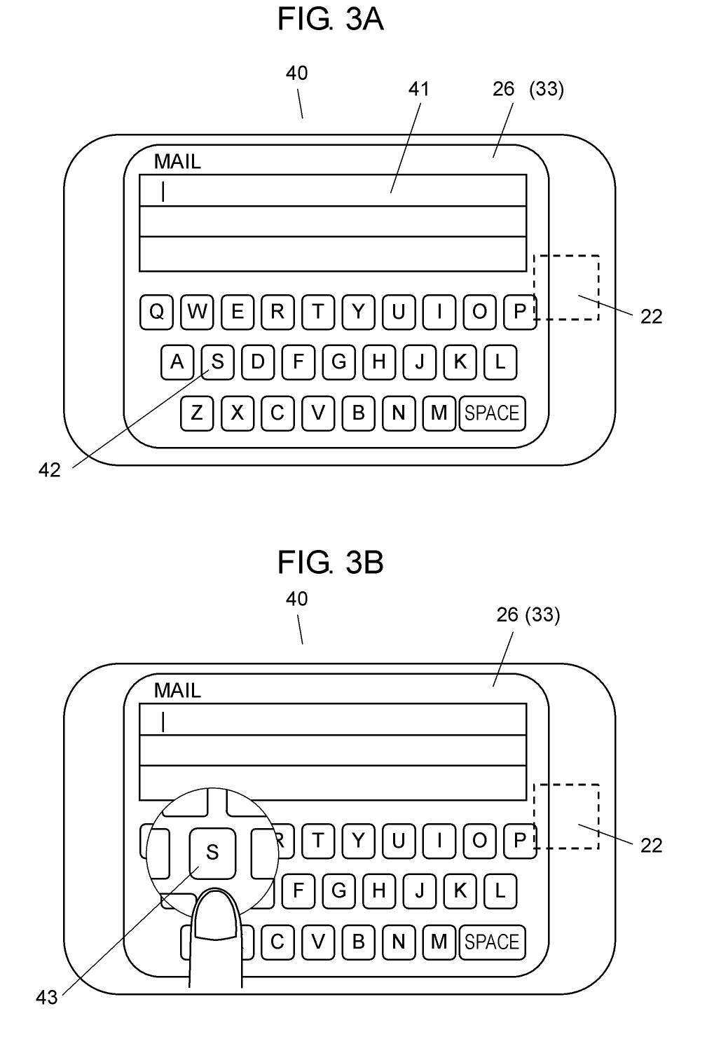

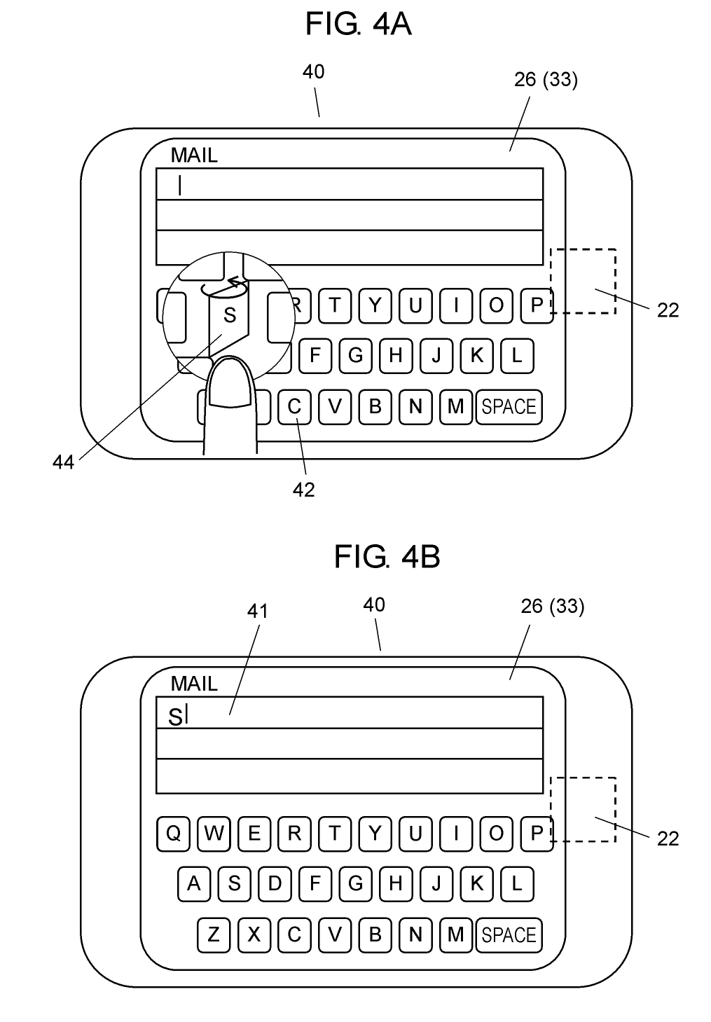

FIG. 3A is a top view of the electronic apparatus using the input device in accordance with the embodiment. FIG. 3B is a top view of the electronic apparatus using the input device in accordance with the embodiment. FIG. 4A is a top view of the electronic apparatus using the input device in accordance with the embodiment. FIG. 4B is a top view of the electronic apparatus using the input device in accordance with the embodiment.

FIG. 3A shows an initial display when text to be transmitted by electronic mail is formed. On display element 26, text display part 41 and a plurality of keys 42 are displayed. At this time, a control mode of control circuit 22 is an input mode (input state) for waiting for an input to keys 42 by an operator.

In this state, as shown in FIG. 3B, when an operator touches a top surface of touch panel 33 corresponding to key 42 of a character “S” with the finger, the control mode of control circuit 22 changes from the input mode to a standby mode (standby state). That is to say, when the pressing force is not larger than P1 (a predetermined first value and 0 in this embodiment), control circuit 22 sets touch panel 33 to the input mode. When the pressing force is larger than P1, control circuit 22 sets touch panel 33 from the input mode to the standby mode.

When control circuit 22 changes to the standby mode, based on a signal from touch panel 33 and a signal from pressure-sensitive sheet 32, control circuit 22 transmits a signal, for displaying enlarged display 43 enlarging key 42 of a character “S” in the vicinity of a position with which the finger is brought into contact, to the display element.

When the operator further increases the pressing force on touch panel 33, while the control mode of control circuit 22 is maintained in the standby mode, control circuit 22 displays rotational display 44 on display element 26 as shown in FIG. 4A in which rotation of the character “S” is projected as a two-dimensional display.

That is to say, since the character “S” is displayed as enlarged display 43 or rotational display 44 in the standby mode, the operator can visually recognize which character is chosen. That is to say, the operator is visually notified that the mode is the standby mode.

When the operator further increases the pressing force on touch panel 33 and when the pressing force is larger than P2 (a predetermined second value that is larger than the first value), control circuit 22 carries out deciding processing, so that the character “S” is decided and displayed on text display part 41 as shown in FIG. 4B. Then, after the deciding processing, the control mode of control circuit 22 changes from the standby mode to the input mode. That is to say, when the pressing force is larger than P2, the control circuit decides an input to the touch panel, and sets the touch panel to the input mode.

Alternatively, when the operator reduces the pressing force on touch panel 33 and moves the finger off touch panel 33, control circuit 22 does not carry out the deciding processing and control circuit 22 changes the control mode from the standby mode to the input mode. Furthermore, the display on display element 26 returns to the display shown in FIG. 3A.

That is to say, with the configuration in which the control mode of control circuit 22 includes the standby mode, an operator moves the finger off touch panel 33 before control circuit 22 carries out deciding processing. Thus, an input error can be avoided. Furthermore, since control circuit 22 notifies an operator of the chosen character, when a character that is not intended by the operator is chosen, the operator can easily avoid an input error.

A display for notifying an operator that the mode is the standby mode is not limited to enlarged display 43 and rotational display 44, and any displays capable of notifying an operator that the mode is the standby mode may be employed. For example, in the standby mode, a frame of the character “S” may be changed into a circular shape or a star shape.

Furthermore, aside from display element 26, display part 50 for notifying that the mode is the standby mode may be disposed so that control circuit 22 displays display part 50 in the standby mode.

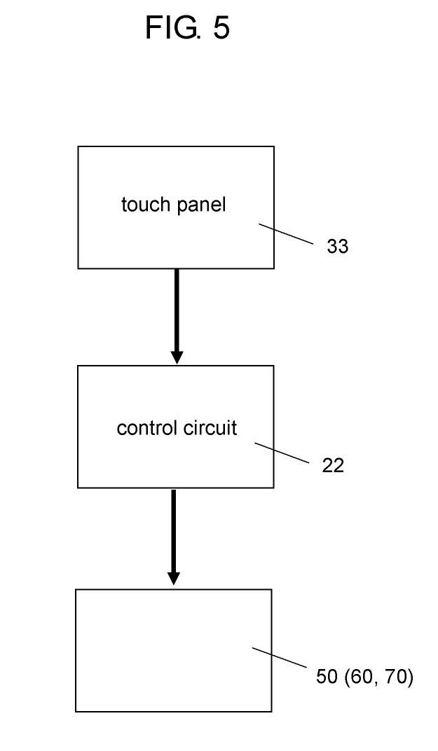

FIG. 5 is a block diagram showing a relation among touch panel 33, control circuit 22 and display part 50 in accordance with this embodiment. As shown in FIG. 5, when an operator presses touch panel 33 and a pressing force is larger than P1 and not larger than P2, control circuit 22 activates display part 50 to display a character, a picture, or the like.

When an operator is notified that the mode is the standby mode, touch panel 33 may be vibrated. For example, touch panel 33 may be configured so that vibration is conveyed from a vibration motor in which a load is biased by a motor or in which a weight is rotated or from an element such as a piezoelectric element for generating vibration, resulting in vibrating the top surface of touch panel 33 in the standby mode. This makes it possible to allow the operator to recognize that the control mode of control circuit 22 is the standby mode by using the sense of touch of the operator. That is to say, in FIG. 5, vibration part 60 instead of display part 50 may be disposed.

When an operator is notified that the mode is the standby mode, a sound may be used. For example, an electronic apparatus may include sound generation part 70 so that a predetermined notification sound or a sound corresponding to chosen key 42, for example, “e-su” is generated from sound generation part 70 in the standby mode, resulting in notifying the operator that the mode is the standby mode. This configuration makes it possible to allow the operator to recognize that the control mode of control circuit 22 is the standby mode by using the sense of hearing of the operator. With display element 26 capable of changing a display, but also with, for example, a configuration in which a touch panel is disposed on the top surface of a pressing switch, the present embodiment can be carried out by notifying an operator by using a sound. That is to say, in FIG. 5, instead of display part 50, sound generation part 70 may be disposed.

Furthermore, when a pressing force of an operator is detected, by determining, for example, a voltage value output from touch panel 33 by control circuit 22, the pressing force of the operator may be detected. Thus, input device 35 can be configured without including pressure-sensitive sheet 32.

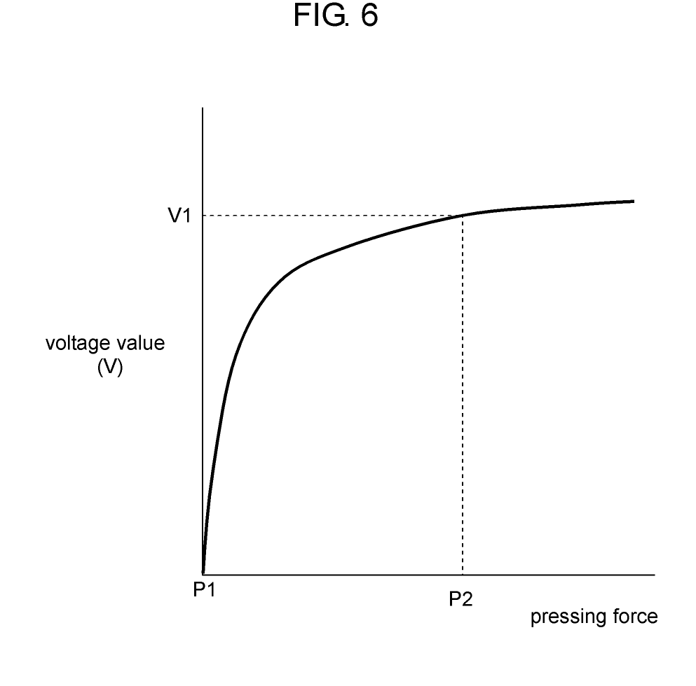

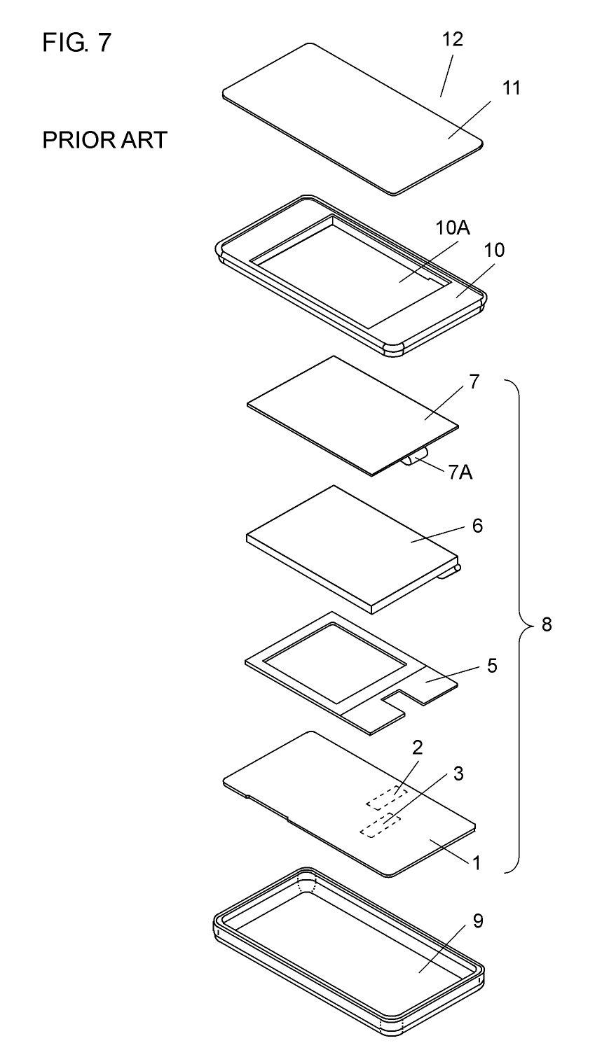

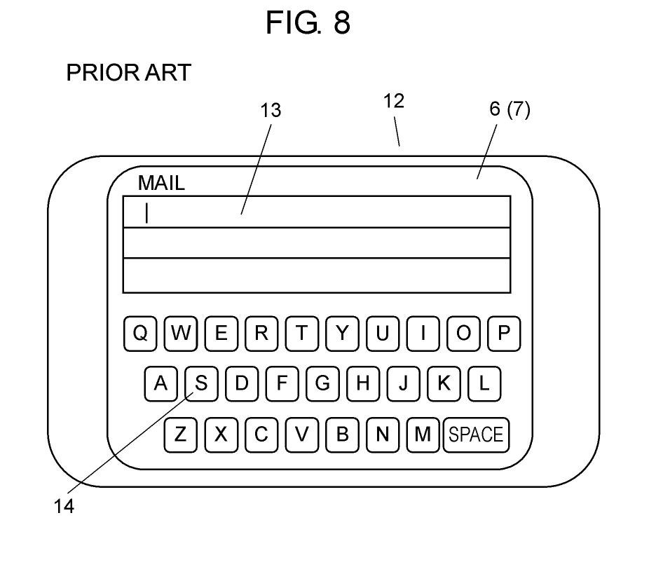

FIG. 6 is a graph showing a relation between a pressing force on the top surface of touch panel 33 and a voltage value input to control circuit 22 in input device 35 in accordance with the embodiment. When the pressing force on the top surface of touch panel 33 is increased, an area in which the top surface of touch panel 33 and the finger are brought into contact with each other is increased. Accordingly, the voltage value input to control circuit 22 is increased.

Control circuit 22 is in the standby mode after the finger of an operator is brought into contact with the top surface of touch panel 33 and during a time in which the voltage value is not larger than predetermined voltage value V1. At a time when the voltage value is larger than predetermined voltage value V1, that is to say, at a time when the pressing force is larger than predetermined pressing force P2, control circuit 22 carries out deciding processing. Control circuit 22 is in the standby mode after the finger of the operator is brought into contact with touch panel 33 and during a time in which the pressing force is not larger than the predetermined pressing force P2. Therefore, when the operator moves the finger off touch panel 33 before control circuit 22 carries out the deciding processing, control circuit 22 returns to the input mode.

The deciding processing is processing for deciding selection of key 42 displayed on display element 26 or a displayed menu when a menu or the like is displayed on display element 26 by an operator's pressing the top surface of touch panel 33. The deciding processing does not necessarily display the contents of decided selection on display element 26.

According to this embodiment, control circuit 22 sets touch panel 33 to the input mode or the standby mode. When a pressing force on touch panel 33 is not larger than P1, the mode is the input mode. When the pressing force is larger than P1 and not larger than P2, the mode is the standby mode. In the standby mode, when the pressing force is larger than P2, control circuit 22 decides the input to touch panel 33, and then sets touch panel 33 to the input mode. In the standby mode, when the pressing force returns to not larger than P1 before it reaches predetermined pressing force P2, control circuit 22 sets touch panel 33 to the input mode without carrying out deciding processing. Since an operator can move the finger off touch panel 33 before the deciding processing and then return to the input mode, an input error can be reduced.

When control circuit 22 is in the standby mode, an operator is notified that control circuit 22 is in the standby mode through any one of the sense of sight, the sense of touch and the sense of hearing. Therefore, since the operator can recognize the standby mode corresponding to a pressing force, an input error can be reduced.

In this embodiment, pressing force P1 is made to be 0 Pa (pascal), but it can be made to be a predetermined value instead of 0. When pressing force P1 is made to be a predetermined value instead of 0, for example, in a case where electronic apparatus 40 using input device 35 is placed in a bag, it is possible to prevent an input error when a pressing force is applied.

An input device in accordance with the present embodiment has an advantageous effect capable of reducing an input error, and is useful for operating various electronic apparatuses.

What is claimed is:

1. An input device, comprising:
a touch panel; and
a control circuit electrically coupled to the touch panel and operable to determine a pressing force on the touch panel, wherein:
when the control circuit determines the pressing force is not larger than a first predetermined value, the control circuit sets the touch panel to an input state,
when the control circuit determines the pressing force is larger than the first predetermined value and not larger than a second predetermined value that is a larger value than the first predetermined value, the control circuit sets the touch panel to a standby state, and
when the control circuit determines the pressing force is larger than the second predetermined value, the control circuit decides an input to the touch panel and sets the touch panel to the input state.

2. The input device according to claim 1, further comprising:
a display element disposed at a rear side of the touch panel and operable to display a key for allowing the control circuit to carry out processing.

3. The input device according to claim 2,
wherein in the standby state, the control circuit changes a display of the key.

4. The input device according to claim 1, further comprising:
a display element operable to display a result after the input is decided.

5. The input device according to claim 1, further comprising:
a pressure-sensitive sheet disposed at a rear side of the touch panel and electrically coupled to the control circuit,
wherein the pressure-sensitive sheet is operable to perceive the pressing force on the touch panel.

6. The input device according to claim 1, further comprising:
a display element operable to display a display part for notifying of the standby state,
wherein in the standby state, the control circuit displays the display part on the display element.

7. The input device according to claim 1, further comprising:
a vibration part operable to provide notification of the standby state,
wherein in the standby state, the control circuit vibrates the vibration part.

8. The input device according to claim 1, further comprising:
a sound generation part operable to provide notification of the standby state,
wherein in the standby state, the control circuit generates a sound from the sound generation part.

9. An input device comprising:
a pressure-sensing device operable to sense an amount of pressure applied by a user against the input device and operable to provide an output based upon the pressure applied by the user;
a control circuit operable to receive the output of the pressure-sensing device, determine a pressing force based on the received output of the pressure-sensing device, and set a state of the input device based upon the determined pressing force, wherein:
the control circuit sets the input device to an input state when the control circuit determines the pressing force is not larger than a first predetermined value;
the control circuit sets the input device to a standby state when the control circuit determines the pressing force is larger than the first predetermined value and not larger than a second predetermined value, the second predetermined value being larger than the first predetermined value; and
the control circuit accepts an input into the input device and sets the input device into the input state when the control circuit determines the pressing force is larger than the second predetermined value.

10. The input device according to claim 9, wherein the input state is a state in which the input device is made operable to await a user selection, and the standby state is a state in which the user is prompted to confirm a user selection.

11. The input device according to claim 10, further including a display part operable to display a plurality of keys, wherein in the input state, the input device awaits a user selection of one of the plurality of keys and, in the standby state, a display of the selected one of the plurality of keys is changed to prompt the user confirmation.

12. The input device according to claim 11, further comprising a user notification part operable to notify the user of the selected one of the plurality of keys when the input device is in the standby state.

13. The input device according to claim 12, wherein the notification part is either a sound generation part operable to output a sound or a vibration part operable to output a vibration.
